(19) United States
(12) Patent Application Publication
(10) Pub. No.: US 2011/0265494 A1
(43) Pub. Date: Nov. 3, 2011

(54) Production of Liquefied Natural Gas

(75) Inventor: Michael Barclay, Berkshire (GB)

(73) Assignee: DPS Bristol (Holdings)Ltd, Bristol (GB)

(21) Appl. No.: 13/055,110

(22) PCT Filed: Jul. 27, 2009
(86) PCT No.: PCT/GB2009/050923

§ 371 Date: May 13, 2011

(30) Foreign Application Priority Data
Jul. 25, 2008 (GB) 0813690.5

(51) Int. Cl. F17C 3/00

(52) U.S. Cl. 62/45.1

(57) ABSTRACT

A liquefied natural gas production and storage scheme for offshore liquefaction of stranded gas reserves using a processing vessel and a liquefaction and storage shuttle vessel. The processing vessel includes the typical steps of condensate management, pre-treatment and compression. The processing vessel also recompresses a recycle gas from the LNG production and storage vessel. The high pressure, treated natural gas is fed to the LNG production and storage vessel that has minimal processing equipment consisting of at least a heat exchanger, an isentropic expander, a separator vessel, and a small LP compressor. The liquefier on the liquefaction and storage vessel are designed to generate a high liquid yield without the need for excessive operating pressures or multiple refrigerants circulating between vessels.

### BACKGROUND OF THE INVENTION

This invention relates to a method for offshore production of liquefied natural gas (LNG), wherein the gas is supplied from an underground reservoir as either associated or non-associated gas. In the case of the associated gas, that gas which is produced in association with oil production, the gas is often problematic because there is no way to transport it to market in the absence of a pipeline. This gas has often historically been flared. More recent aspirations to decrease the environmental consequences of producing oil has increasingly led to the gas being reinjected into underground reservoirs. This is costly and not always practical. Liquefaction of this gas offers a way to transport this gas to market by increasing the fluids density at low temperatures.

Increasingly, non-associated stranded gas field have been considered for the liquefaction of natural gas to allow these stranded resources to be monetised. Offshore liquefaction of natural gas has not yet seen widespread implementation because of a few fundamental limits. LNG is required to be produced and stored at low temperatures. This introduces a number of challenges.

The first challenge is that low temperature operations require special couplings, metallagy, and design. Many materials, including those that normal ship transfer operations depend upon, become brittle, freeze, or contract and leak when subjected to the cryogenic temperatures required for LNG.

Particularly troublesome are flexible cryogenic transfer hoses that could be used to allow ship to ship transfer of cryogenic fluids or LNG. In contract to well-established, proven, and cost effective ambient temperature ship to ship and field to ship fluid transfer lines, cryogenic ones cannot yet be considered cost effective or proven. Whilst these are slowly entering the market place, they are essentially unproven in marine service, the technology is expensive and held by a few parties.

The second major issue is that liquefaction of LNG requires several processing steps and is energy intensive. It is impractical to treat, liquefy, and store LNG on a vessel that is also used to transport the LNG to market because the processing equipments size and cost will make such schemes un-economic. In particular, the compression costs including drivers and heat exchanger costs and size mean that it is challenging to cost effectively package LNG process equipment into offshore systems.

A method and apparatus of obtaining LNG from offshore deposits is known from patent U.S. Pat. No. 5,025,860. In the known system, the natural gas is purified and compressed on one vessel or platform. The work input to the refrigeration cycle is applied to the feed gas in the form on the first vessel. This high pressure, purified gas is transferred via pipeline to a second vessel equipped with an expansion-based liquefaction process equipment for condensation of a portion of the feed gas into LNG was well as storage capacity for the LNG. The non-liquefied portion of the feed gas was returned to the first vessel for recompression. This prior art recognized the value of avoiding cryogenic transfer lines but failed to recognize the importance of a high yield liquid yield from the liquefaction cycle to decrease the gas that circulates through the system as well as the work input to the process. In this context a liquid yield refers to the fraction of liquid formed relative to the gas that is recycled. A second failing of the prior art was that it didn't teach to minimize the complexity and cost of the LNG production equipment on the LNG storage vessel. This is important because there are multiple LNG production and storage vessels for a single gas processing vessel.

U.S. Pat. No. 5,878,814 recognized the value of maximizing the liquid yield and also captured advances in the field associated with offshore vessel couplings. This patent teaches a scheme whereby LNG flowed directly from a subsea production plant to an LNG production and storage vessel resulting in almost complete liquefaction. This patent introduced STP technique (Submerged Turret Production) for connection to the LNG production and storage vessel using a submerged buoy with swivel for the transfer of fluids. This patent also introduced the use of isentropic expanders to increase the efficiency/liquid yield on the production and storage vessel. Since this scheme consisted of a single vessel, the original recycle concept between two vessels taught in U.S. Pat. No. 5,025,860 was not followed. This scheme would require extensive process equipment to be on the storage and production vessel including some means to dehydrate, remove acid gas components like CO2 and H2S, some form of condensate management and storage. This will result in a storage and transfer vessel that is not cost effective because storage capacity is displaced by processing topsides and the cost increases because all the LNG vessels deployed need processing equipment that is only utilized when the vessel is producing LNG connected to the turret.

Patent U.S. Pat. No. 6,003,603 further developed the art by adding a second to the scheme that included acid gas treatment, dehydration, and condensate management. This system recognized the benefits of high liquid yield on the LNG production and storage vessel and included provision for isentropic expansion of the feed gas, very high pressure transfer of the feed gas (250-350 bar), and subcooled transfer of the feed gas to the LNG production and storage facility. Like patent U.S. Pat. No. 5,878,814 this patent taught essentially 100% liquid yield without a recycle of residue gas and also taught of the feed gas leaving the treatment vessel as either a hot compressed gas in a non-insulated line or a very cold gas in a insulated. As those familiar with the art will recognize, natural gas is typically liquefied at pressures between 50-75 bar because this is high enough to provide efficient liquefaction but low enough that feed gas compression and high design pressures of equipment become cost prohibitive. Patent U.S. Pat. No. 6,003,603 as well as U.S. Pat. No. 5,878,814 teach of feed pressures between 250-350 bar which are too high for cost effective liquefaction of natural gas and likely result in reduced inherent safety.

Patent U.S. Pat. No. 6,889,522 teaches of another 100% LNG liquid yield process that avoids cryogenic transfer of liquids by employing closed loop, gas expander processes. The compression is again located on the first vessel, while the cryogenic processing equipment is located on the LNG liquefaction and storage vessel. This process suffered by the need for multiple feed and recycle lines between vessels to accommodate the close loop refrigerants, complexity on the LNG production and storage vessel, and multiple compressors and drivers on the first vessel to compress the feed gas and the refrigerant streams. Those skilled in the art will recognize the importance of minimizing compressors and compression stages to cost effective LNG production.

The current invention remedies the shortfall of the prior art by providing a system that avoids cryogenic transfer lines whilst providing a high liquid yield on the liquefaction and storage vessel, uses a single feed and a single recycle gas line between the vessel, and offers economic liquefaction at reasonable operating pressures.

### SUMMARY OF THE INVENTION

For the achievement of the above mentioned improvements the following method and apparatus are disclosed:
1. a first vessel (the Processing Vessel) has essentially all the gas, and if present, oil processing equipment required except those components that operate at very low temperatures including a large feed gas compressor;
2. the pre-treated, compressed feed gas is send to a second vessel (the LNG Vessel) through a cost effective non-cryogenic line and couplings;
3. the LNG Vessel contains all the cryogenic equipment required to generate a high-yield of LNG based on a Claude type liquefaction cycle and including a minimum of a heat exchanger, a LP compressor, an isentropic expander, and a liquid expansion device immediately upstream of a separator vessel. This liquefaction process is open cycle and liquefies only a portion of the feed gas;
4. the non-liquefied portion of the feed gas is returned to the Processing Vessel through a well proven, non-cryogenic line and couplings where it can be re-compressed in the feed gas compressor.

This Processing vessel is similar to existing FPSOs or platform production facilities. Additional, or enhanced processing facilities on the Production Vessel relative to a traditional FPSO will likely include molecular sieve dehydration, removal components acid gas components such as CO2 and H2S that will freeze in cryogenic process equipment, mercury removal that attack aluminium cryogenic process equipment, and some form of condensate management.

The production facility will also include gas compression that is configured to allow high yield liquefaction of the LNG that is transferred to the LNG vessel. Compression pressure stages and levels will be optimized to minimize the number of drivers and stages whilst considering the recycle gas pressure and the gas gathering compression if present.

One of the novel features of the present invention is to add some heat exchange between the compressed feed gas and the LP recycle gas on the Processing Vessel. In the open cycle expander-based liquefaction cycle, the heat exchange between the feed gas and the recycle gas represents a significant portion of the overall heat exchange and requires significant surface area. Locating at least a portion of this heat exchanger on the Processing Vessel may offer some benefits:
1. Decreased cost and liquefaction system weight of the LNG vessel processing equipment whilst ensuring a tight temperature approach between the process stream to increase LNG liquid yield;
2. Brings a source of cold energy to the Processing Vessel that could be used to manage condensate;
3. Facilitates introduction of an additional precooling refrigerant located solely on the Processing Vessel.

The heat exchanger will not be used in all cases because it requires the recycle gas to be cooler than the feed gas. This may not always be the case depending on what type of device loads the expander and how much flash gas is produced. The inter-ship circulation temperatures be such that unproven or special cryogenic coupling will be needed.

The pretreated, compressed, and partially cooled feed gas is transferred to the LNG vessel that includes all the very low operating temperature equipment as well as the LNG storage. Those skilled in the art will recognize that the LNG Vessel will have some key features:
1. The LNG production facility costs and space on the LNG Vessel will represent only a small incremental adder to the complexity and costs that vessel such that it will be cost effective to have the equipment on multiple LNG Vessels;
2. The liquefaction equipment will offer a high liquid yield to avoid excessively high flow of recycle gas to the Processing Vessel and associated compression costs;
3. The vessel will be designed to shuttle the LNG to market such that it can connect to the Processing Vessel, be loaded with LNG, disconnect from the Processing Facility, and take the LNG to market;
4. The liquefaction process must be highly operable and must minimize the time when the LNG Vessel isn't either producing LNG or either returning from or moving to an LNG offloading facility.

To accomplish the high liquid yield of LNG in the LNG Vessel, an open cycle Claude (expander-based) liquefaction cycle will be used. It should be noted that there are many variations to this process that can be deployed depending on the nature of the process gas. For example, there could be multiple staged flashing stages to produce and LNG product, the liquid fraction from the expander could be separated and combined with the LNG stream prior to a final flash, etc. For the purposes of the current invention, the minimum equipment present on the LNG Vessel shall be identified. The LNG Vessel liquefaction process equipment shall include at least:
A heat exchanger to recover the cold energy from the flash gas, isentropically expanded fluid, and other cold sources against the warmer higher pressure fluids;
At least one hydrocarbon expander that isentropically expander partially cooled compressed feed gas with some form of work recovery with either compressor or generator loading;
At least one other product expansion device (turbine or JT valve) that expander a portion of the cooled feed gas into a two-phase mixture of gas and liquid;
a LP Offgas compressor that recompresses flash gas off at least one of a flash vessel downstream of the product expansion device and boil off gas from storage.

The isentropic expansion is important because the efficient expansion is an integral part of a high liquid process. As those skilled in the art will appreciate, close matching of cooling curves and the reversibility of expansion processes are two of the essential elements for efficient liquefaction, which in this case, manifests itself in high liquid yield.

The LP flashgas compressor, that is small compared to the main feed gas compressor(s), may also be used as the prime mover for a boil off gas (BOG) liquefaction cycle when the LNG vessel is not connected to the Processing vessel.

### DESCRIPTION OF THE DRAWINGS

The invention will be further described below in connection with the drawing FIG. 1 and FIG. 2.

FIG. 1 is a schematic view showing the fundamental construction of a system according to the invention;

FIG. 2 is a schematic showing the essential elements of the scheme and the relative locations of all the elements.

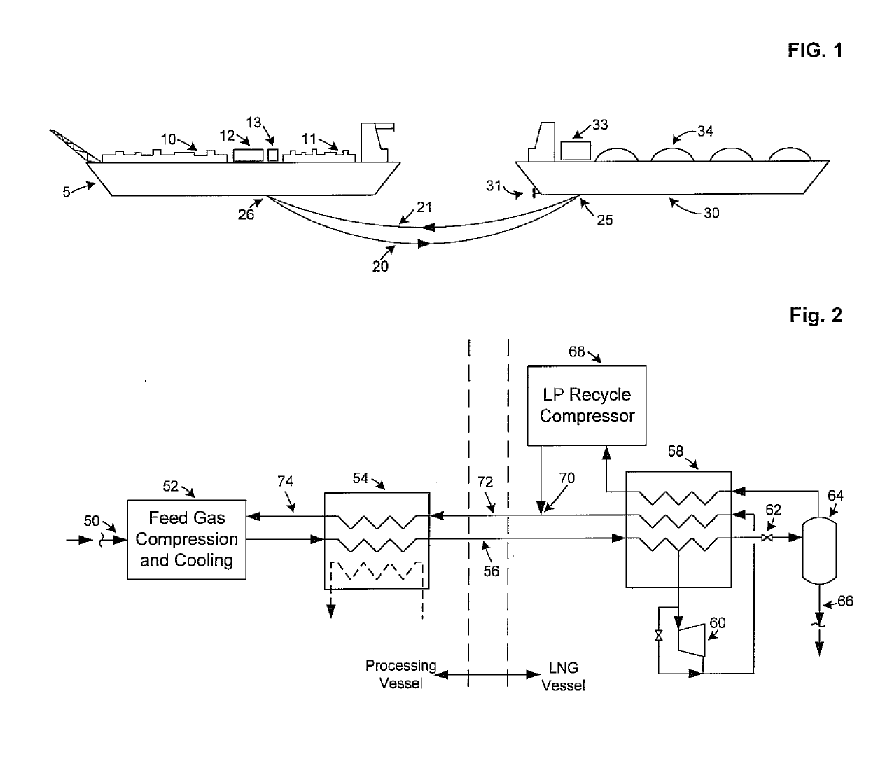

Referring to FIG. 1, the Processing Vessel 5 is shown illustratively with some oil processing topsides 10 and some gas processing topsides 11. Whilst this vessel is shown as an FSPS in associated gas service, this is not intended to restricted as the current method applies equally well to any offshore production facility including those on floating and non-floating platforms, gravity based structures, and floating vessels. Additionally, whilst the sketch shows oil and gas processing facilities on the same vessel, it is easy to imagine a larger capacity facility requiring separate oil and gas processing vessels or indeed, a processing facility producing only gas.

The gas processing facilities 11 will consist of some means to remove at least water, CO2, and C5+ components such as benzene that are known to freeze or crystallize in LNG. In the preferred embodiment, these processing facility will include amine acid gas removal, followed by molecular sieve dehydration, and a fixed absorbent mercury removal bed. This is not intended to be limiting. These process blocks may be combined or separated and may be of adsorbent, adsorbent, and other methods. For instance, these steps could include removal of C5+ with water in an adsorbent step followed by CO2 in a second adsorbent step. This treatment may also include compression associated with associated gas production to pressure suitable for dehydration and acid gas removal.

Following treatment and possible gas gathering compression, the gas is compressed, along with the recycle gas stream from the LNG Vessel, in Feed Gas Compression 12 to a pressure well suited for high liquid yield open cycle liquefaction in the second vessel 30. The pressure range will be no lower than approximately 50 bar to ensure the feed gas will have an approximately linear/continuous cooling curve and typically in the 70-100 bar range such that the hydraulic losses through refrigeration loop will be very small relative to the differential across the feed gas compressor 12, the LNG liquid yield is at least 20% by mass, excessive volumetric pressures and large associated equipment are avoided, and excessive pressures are avoided in the cryogenic processing equipment 33 on the LNG Vessel 30.

The feed gas compression 12 also includes aftercooling by either seawater or ambient air. Following compression and after cooling in 12, the compressed pre-treaded feed gas is at least partially cooled in recuperative heat exchanger 13. The extent to the cooling will be dependent on optimization for the specific plant however the primary benefits of shifting process equipment from the LNG Vessel 30 to the Processing Vessel 5 and improving performance. In the preferred embodiment, heat exchanger 13 will be a highly effective aluminium plate fin well proven in cryogenic service. The feed gas will not be cooled to a point where either stream looses any of the benefits of avoiding cryogenic fluid transfer between vessels.

The compressed, partially cooled feed gas then leaves the Processing Vessel 5 through interface 26 and flows through feed line 20. The specific embodiment of the vessel to line interfaces 25, 26 for the feed line 20 or recycle line 21 does not change the fundamental benefits of the present invention. These interfaces could be of the bridge, swivel turret, or couple types; the essential feature is that they do not operate under cryogenic temperature conditions.

The feed gas enters the liquefaction processing equipment 33 on the LNG Vessel 30 where it is cooled, expanded, and at least partially condensed into an LNG product for storage in the LNG storage 34 present on the vessel. The liquefaction processing equipment consist of some variant of the open-cycle Claude liquefaction process that combines at least one isentropic expansion of the gas-line process fluid with at least additional expansion of a liquid-like portion of the process fluid to produce a liquid product.

There are many variants of Claude-type processes, and the specific embodiment is not relevant to the present invention. The essential elements are that it is an open cycle process, includes at least one isentropic expansion, and offers a high liquid LNG yield.

The un-liquefied portion of the gas is returned via the recuperative heat exchanger 13 to feed gas compression 12 and is recompressed to complete the refrigeration cycle. The quantity of recycle gas and the capacity of the feed gas compressor 12 is a function of LNG yield and the process efficiency and is an element to the viability of the scheme.

When the LNG storage 34 on the LNG Vessel 30 fills, the pipeline interface 25 with that vessel is disconnected and the LNG Vessel 30 may transport the LNG to an offloading facility. Another LNG Vessel is connect to the interface 25, and resumes the recycle of the process gas and liquefaction of LNG.

In an alternate embodiment not shown, multiple LNG Vessels may be connected to the Processing Vessel 5 at the same time to eliminate any disruption of LNG production when a single LNG Vessel 30 is disconnected from the recycle pipelines. This embodiment requires a system where there are at least two LNG Vessel interfaces 25 in some form of manifolded arrangement.

When the LNG Vessel 30 is disconnected from the Processing Vessel, heat leak into the LNG storage will either increase the pressure of the LNG or produce a vapor called boil off gas (BOG). In one embodiment of the current invention, the BOG is recondensed using the LP Offgas Compressor 68 seen in FIG. 2.

FIG. 2 shows an embodiment schematically showing the relative relationship of the process equipment. The treated feed gas 50 is compressed and aftercooled in the feed gas compression and cooling block 52. This block compresses the recycle gas from the LNG Vessel 72 after it has been warmed heat exchanger 54. Heat exchanger 54 is an optional block that may offer an opportunity to shift process equipment and associated cost from the LNG Vessel to the Processing Vessel. This is advantageous because there are more than one LNG Vessels per Processing Vessel. Additionally, it is an opportunity to integrate closed loop refrigeration to increase LNG liquid yield that again would be located on the Processing Vessel. The feed gas flows to the LNG Vessel in line 56. All the cryogenic process equipment is located on the LNG Vessel and includes at least one isentropic expander 60 that operates at a higher inlet temperature than at least one other expansion device 62 and a product flash vessel 64. This is achieved by drawing off a proportion of the gas flowing in the line 56 at a point which is part of the way through a heat exchanger 58. The remainder of the gas is supplied to the expansion device 62 which causes some of the gas to liquefy. The resulting LNG is collected in the flash vessel 64.

A recycle gas compressor 68 must compress at least a portion of the gas from the flash vessel 64, associated with at least one product flashes stage, to a lower pressure than the discharge pressure of the expander 60. The expander is expected to attempt to isentropically expand the partially cooled feed gas resulting in a large drop in temperature. The expander transmits the work associated with the expansion to a compressor, generator, or other means and may have a two phase outlet. This liquid may be directed with the gas back to heat exchanger 58, or may be further expanded and mixed with the LNG or stream or be used to provide additional cooling. At least one heat exchanger 58 is used to exchange heat between the high pressure feed gas, at least a portion of the expanded fluid, flash gas, and other cold gases that may not be shown such as BOG.

The LP Recycle Compressor 68 compresses lower pressure gases to the main return pressure and may include an aftercooler in some cases. The recycle gas is returned via line 72 to optional heat exchanger 54 or feed gas compression 52 where it is recompressed so that it can be recycled back to the liquefaction process equipment.

1. A method of producing natural gas in an maritime environment comprising the steps of:
Obtaining a flow of natural gas from an offshore field onboard one of a production platform or a production ship
Treating the flow of natural gas in preparation for liquefaction including at least one of hydrogen sulphide, mercury components, water, and carbon dioxide removal;
Compressing and aftercooling the flow of treated natural gas;
Transferring said natural gas to a second vessel equipped with LNG storage without the use of cryogenic transfer lines;
Using a liquefaction process with at least one isentropic expansion to offer a high liquid yield of LNG that is stored on said vessel;
Returning the non-liquefied portion of the gas to the compression on the production platform or a production ship via a non-cryogenic transfer line such that it is recompressed to be recycled as part of the liquefaction process.

2. A method as set forth in claim 1 wherein the flow of natural gas from the offshore field was produced in association with crude oil production.

3. A method as set forth in claim 1 wherein at least a portion of the heat exchange between the two vessels occurs on the production platform or a production ship.

4. A method as set forth in claim 1 wherein the feed gas is compressed to a pressure of between 50 and 100 bar prior being transferred to the LNG storage vessel.

5. A method as set forth in claim 1 wherein more than one LNG storage vessel may be connected to said production platform or a production ship at a time.

6. A method as set forth in claim 1 wherein the feed gas compressor is driven by a gas turbine.

7. A method as set forth in claim 6 wherein the fuel gas for the gas turbine is preferentially sourced from the gas being recycled from the LNG storage vessel.

8. A method as set forth in claim 1 wherein the regeneration gas for any molecular sieve beds is preferentially supplied from the gas being recycled from the LNG storage vessel.

9. A system for offshore partial liquefaction of a pretreated, compressed natural gas stream into a LNG fraction and a reduced pressure gaseous faction that generates a high yield of LNG by isentropically expanding a portion of the cooled feed gas in a turboexpander, expanding a second portion of the feed gas with from a lower temperature than the isentropic expander to a lower pressure than the outlet of the turboexpander such that at least one recycle compressor is required and a liquid product is formed.

10. The system as set forth in claim 9 wherein the recycle compressor is one of an integrally geared or a screw type compressor.

11. The method as set forth in claim 9 wherein the recycle compressor shaft power demand is no more than 10% of the power required to compress the recycle gas pressure to the feed gas pressure.

12. A system according to claim 9 where the LP compressor compresses a portion of the boil off gas as well as flash gas after said gases are warmed.

13. A system according to claim 9 where the LP compressor is used as part of a boil off gas re-liquefaction process when LNG storage vessel is disconnected from the product vessel.

14. A system according to claim 9 wherein the expansion resulting in an LNG stream is accomplished in a flashing expander approximating an isentropic expansion and having a two phase outlet.

15. A method in claim 1 wherein the LNG storage vessel disconnects from the feed and recycle lines once it is full with LNG and transports the LNG to an offloading facility in another location.
